(19) United States
(12) Patent Application Publication
(10) Pub. No.: US 2008/0154671 A1
(43) Pub. Date: Jun. 26, 2008

(54) Emissions Tracking, Such as Vehicle Emissions Tracking, and Associated Systems and Methods

(76) Inventor: Louis D. Delk, Tucson, AZ (US)

Correspondence Address: PERKINS COIE LLP;PATENT-SEA, P.O. BOX 1247, SEATTLE, WA, 98111-1247, US

(21) Appl. No.: 11/815,435

(22) PCT Filed: Mar. 14, 2006
(86) PCT No.: PCT/US2006/009145

§ 371 Date: Aug. 2, 2007

Related U.S. Application Data
(60) Provisional application No. 60/662,186, filed on Mar. 15, 2005.

(51) Int. Cl. G01M 17/00; G06F 7/00

(52) U.S. Cl. 705/7

(57) ABSTRACT

Vehicle emission tracking systems and associated methods can collect emission units associated with at least one vehicle. The emission units can represents (a) an amount of one or more selected pollutants, (b) an amount of thermal energy, or (c) both (a) and (b). The systems and methods can further include computing emission credits by comparing the collected emission units with a baseline, maintaining a total number of emission credits over a selected period of time, and providing a way to assign a portion of the total emission credits to a selected entity.

### CROSS REFERENCE TO RELATED APPLICATIONS

The present application claims the benefit of U.S. Provisional Patent Application No. 60/662,186 filed on Mar. 15, 2005, entitled VEHICLE EMISSIONS TRACKING AND ASSOCIATED METHODS, the entirety of which is incorporated herein by reference.

### BACKGROUND

The rising level of pollutants (e.g., greenhouse gases) in the Earth's atmosphere and the associated affect on the Earth's climate has become a worldwide concern. Because of concerns over the increase in these pollutants, many developing countries agreed to The United Nation's Framework Convention on Climate Change (UNFCCC), which imposed limits on certain types of pollutants. Under the Kyoto protocol to the UNFCCC, various countries are required to limit the emission of certain pollutants to specified levels (e.g., emission caps). Countries can reduce the cost of meeting their emission caps by engaging in emissions reduction trading. For example, international emissions trading allows countries with excess emissions reductions (e.g., voluntary reductions below those required by the specified caps) to use or trade them to offset emissions at another source inside or outside the country.

In the United States, these are state and federal regulations that address pollution. For example, the Clean Air Act allows a regulated source (e.g., a factory) that voluntarily reduces emissions below a specified allowance to sell its unused allowance to another regulated source that is unable to meet regulatory levels. Additionally, the United States Environmental Protection Agency requires that cars produced by automotive manufacturers be capable of meeting certain emission requirements. Various states also have environmental programs. For example, California has an enhanced vehicle emissions inspection and maintenance program (e.g., smog check), which requires vehicles to be periodically inspected and meet specified standards. Additionally, there are federal, state, and local programs that provide incentives for rideshare programs.

### BRIEF DESCRIPTION OF THE DRAWINGS

FIG. 1 is a schematic illustration of an exemplar system for tracking emission units and/or credits in accordance with embodiments of the invention.

FIG. 2 is a schematic illustration of an emission tracking screen used to manage information in a system for tracking emission units and/or credits in accordance with embodiments of the invention.

FIG. 3 is a schematic illustration of a registration screen used to register a vehicle for emission unit and/or credit tracking in accordance with embodiments of the invention.

FIG. 4 is a schematic illustration of a data summary screen used to display information in a system for tracking emission units and/or credits in accordance with embodiments of the invention.

FIG. 5 is a schematic illustration of a trading screen used to trade emission units and/or credits in accordance with embodiments of the invention.

FIG. 6 is a schematic illustration of another trading screen used to trade emission units and/or credits in accordance with embodiments of the invention.

FIG. 7 is a schematic illustration of yet another trading screen used trade emission units and/or credits in accordance with embodiments of the invention.

FIG. 8 is a schematic illustration of the title screen used to track, change, or assign ownership of emission units and/or credits in accordance with embodiments of the invention.

FIG. 9 is a schematic illustration of a document, certificate, or printout that that represents a portion of a user's total emission credits in accordance with embodiments of the invention.

### DETAILED DESCRIPTION

The present invention is directed generally toward vehicle emission tracking and associated methods. One aspect of the invention is directed toward a system for determining emission units that are created or saved over a period of time in relationship to the operation of a vehicle. An emission unit represents an amount of one or more selected pollutants (e.g., greenhouse gases, hydrocarbons, mercury, carbon monoxide, sulfur dioxide, and/or nitrogen oxide) or an amount of thermal energy (e.g., heat), either of which can affect the environment. Emission units can be represented in various ways, including using various measures of weight or volume (e.g., number of particles, cubic feet of gas, and/or pounds of particles) to represent various amounts of pollutants, and/or various measures of thermal units (e.g., BTUs) to represent various amounts of thermal energy. Additionally, in certain embodiments emission units can be represented by other parameters that directly relate to an amount of a selected pollutant. For example, if a specified amount of a selected pollution is emitted by a car for each gallon of gas burned, the amount of gas burned can represent an emission unit.

In certain embodiments, the system can track the amount of emission units that are created during operation of a vehicle and/or the amount of emission units that are saved (e.g., not created) by operating a vehicle in a certain manner and/or not operating a vehicle during certain periods. The emission units can be compared to a baseline to compute or determine emission credits, which represent the amount of emission units that are saved or used in excess of the baseline during a selected time interval or a selected event. For example, in certain embodiments, the baseline can include the amount of emission units that are expected to be used or not used during a certain time interval or event, the number of emission units expected to be used per person carried in the vehicle during a selected time interval or event (e.g., whether all the rideshare users are in a vehicle), and/or a budgeted amount of emission units for a selected time interval or event. In other embodiments, the baseline can include a regulatory limit, a permitted event, an expected pollution level, or other selected or specified thresholds.

For example, in one embodiment when a vehicle emits a smaller amount of selected pollutants than required by local, state, and/or federal regulation, the amount can be represented as an amount of emission units saved or emission credits. In another embodiment, an emission credit can be created when a vehicle is not driven to an emission testing center because required emission testing is accomplished remotely (e.g., via a wireless network and on-board sensors or a mobile emission test center that is carried to the vehicle's location via an electric, hybrid, or other low pollution vehicle). In still another embodiment, an emission credit can be created when an online purchase is made over a network (e.g., the Internet) instead of the vehicle being driven to a retail location or when a vehicle is not driven because the owner participates in a rideshare program. In yet another embodiment, an emission credit can be created when a vehicle is properly maintained (e.g., when proper tire inflation is maintained and/or a vehicle emission system malfunction is promptly repaired). In certain embodiments, an emission credit can be created when a driver chooses a preferred route between two locations and/or operates the vehicle in a way that reduces emissions (e.g., conservative driving with slow acceleration rates). In still other embodiments, emission units can be tracked to insure that regulatory requirements are being met by a single vehicle or by a group of vehicles. For example, an entity (e.g., a state or federal government agency) could monitor the emission units/credits to insure a vehicle or group of vehicles is/are complying with a baseline level of emissions (e.g., regulatory requirements) and, in some cases, issue fines or collect fees for noncompliance with the baseline.

Other aspects of the invention are directed toward tracking and managing the emission units and/or credits. For example, in certain embodiments the emission units and/or credits can be saved and/or stored (e.g., in a computing system). In other embodiments, a running total of emission credits can be calculated, maintained, or tracked for a selected time period and at least a portion of the total emission credits can be assigned to a selected entity (e.g., the ownership of the credits can be reassigned from a first entity to a second entity) in various ways. For example, in selected embodiments a portion of the emission credits can be assigned to a selected entity in exchange for consideration (e.g., for services, merchandise, cash, and/or tax credit). Accordingly, in certain embodiments actual vehicle emissions can be accurately tracked, emission credits can be accurately determined based on vehicle operation or nonuse, and/or operators can be provided with incentives to reduce pollution. In other embodiments, emission credits can be tracked for a group of vehicles, for example, emission credits can be tracked for a fleet of cars owned by a selected company.

Various embodiments of the invention will now be described. The following description provides specific details for a thorough understanding and enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

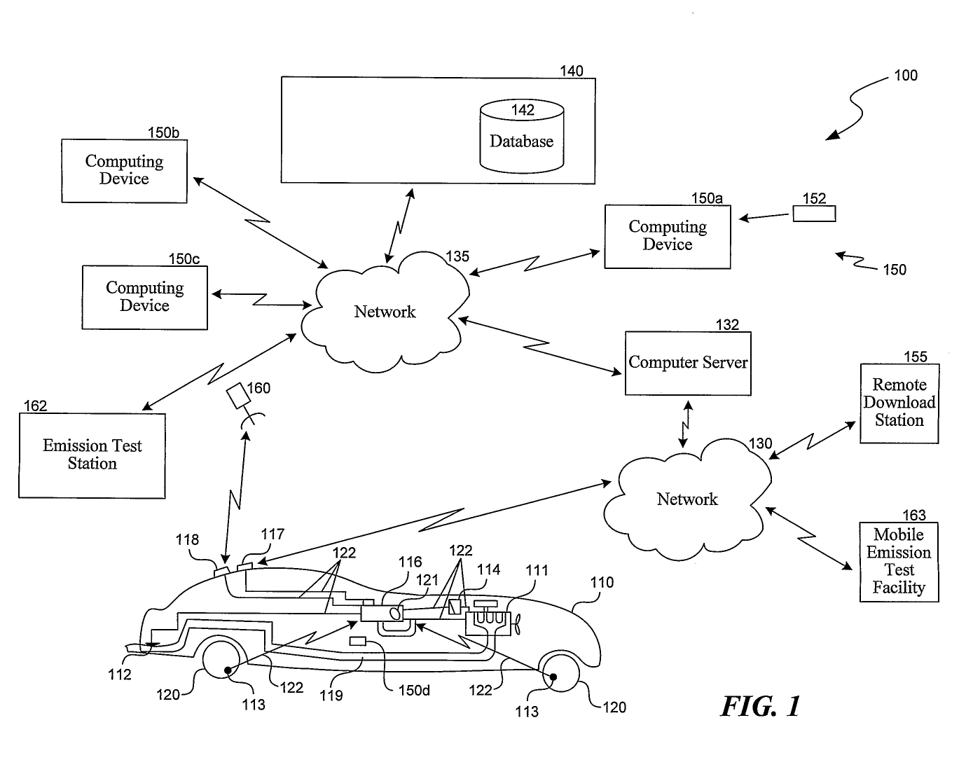

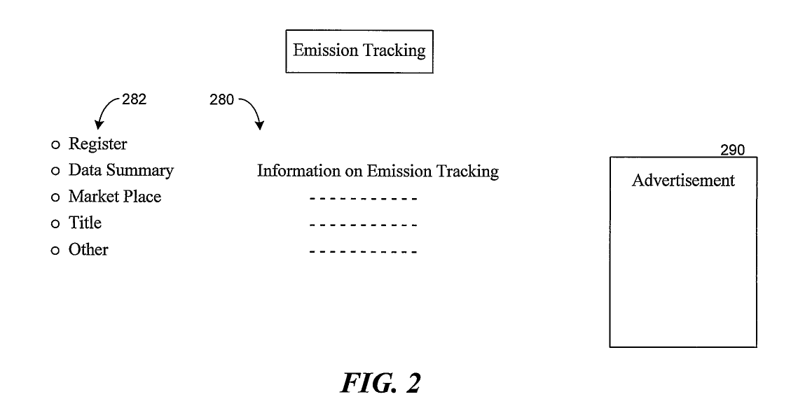

Certain embodiments of systems and methods used to track (e.g., determine, calculate, maintain, total, assign, and/or manage) vehicle emission data and information are described below. FIG. 1 includes an illustration of a system suitable for this purpose in accordance with various embodiments of the invention. FIGS. 2-8 include schematic illustrations of computer displays that can be used to track and/or manage vehicle emission data or information via a computing system in accordance with certain embodiments of the invention.

FIG. 1 is a schematic illustration of an exemplar system 100 used for determining, tracking, and/or managing emission units and/or credits in accordance with embodiments of the invention. In FIG. 1, at least one controller 116 monitors various systems carried by a vehicle 110 or other pollution source and sends information (e.g., data) regarding the systems over at least one network to a computing system 140, where the information can be analyzed, stored, and/or managed. In the illustrated embodiment, the controller 116 communicates with various components carried by the vehicle 110 via communication paths 122. The communication paths 122 can include wired or wireless pathways that transmit data or information between (e.g., to and/or from) the controller 116 and other components in the vehicle 110 (e.g., a local network). For example, the paths 122 can include electrical wires, electrical buses, fiber optic pathways, infrared connections, and/or short range wireless connections (e.g., a Bluetooth interface). In certain embodiments, the controller 116 can communicate with various systems carried by the vehicle 110 through other systems. For example, in one embodiment the controller 116 can communicate with a sensor in the engine through an on-board diagnostic (OBD) system (e.g., OBD-II systems). In other embodiments, the controller 116 can communicate directly to some or all of the systems carried by the vehicle 110.

In FIG. 1, the controller 116 communicates with engine systems 111 (e.g., sensors, electronic control units, and/or OBD systems), sensors 113 that monitor the air pressure in the tires 120, sensors 112 that monitor gases in the exhaust system 119, a positioning system 118, and other systems 114 in the vehicle 110. In other embodiments, the controller 116 can communicate with more, fewer, and/or different systems or components. For example, in certain embodiments other systems 114 in the vehicle 110 can include integrated systems, including a cell phone or a personal computing device configured to interface with the vehicle 110 (e.g., via a Bluetooth connection, a wired connection, and/or other systems or sensors). In other embodiments, the controller 116 can include a system for monitoring whether there are one or more passengers in the vehicle and/or the identity of the passenger(s) in the vehicle (e.g., the controller can monitor whether there are any heat sources in the seats, whether there is weight on the seats, and/or an identifying feature of a cell phone present in the vehicle).

Additionally, in the illustrated embodiment, the controller 116 includes a clock or other timing device so that the information from various systems can be time correlated. In other embodiments, the controller 116 can communicate with an external clock or timing device (e.g., a vehicle clock or the time code available from a GPS receiver or navigation system). In still other embodiments, the information from various systems is not time correlated. In yet other embodiments, the information from the various systems is time correlated during the process of being sent to the computing system 140 or while being received by the computing system 140 (e.g., using a clock in the computing system 140 or in another computing device or computer server used in sending or relaying the information to the computing system 140).

In the illustrated embodiment, the positioning system 118 includes a GPS receiver and antenna which interfaces with a GPS satellite 160. In other embodiments, the positioning system 118 can include other systems or methods for determining position. For example, in certain embodiments the positioning system can include a LORAN system and/or use signal triangulation (e.g., triangulation used by a cellular system to determine the location of a transceiver). In still other embodiments, the positioning system 118 can have other arrangements. For example, the positioning system 118 can include a Global Navigation Satellite System (GNSS) receiver.

The information collected by the controller 116 can be used to determine emission units or credits and/or combined with other information to determine emission units or credits. For example, in certain embodiments the amount of one or more selected pollutants can be directly measured by the sensor 112 in the exhaust system 119 during a period of operation (e.g., from engine start to engine shutdown or from one location to another). The sensor 112 can include any type of sensor that can detect parameters associated with one or more pollutants, including temperature, chemical, moisture, and/or optical sensors (e.g., infrared sensors). In another embodiment, various vehicle parameters can be monitored (e.g., via the OBD system, the electronic control unit, and/or other systems) to determine, compute, and/or estimate the amount of pollutants being emitted during vehicle 110 operations. For example, in the event the vehicle's emission system malfunctions (e.g., a problem with a positive crankcase ventilation valve or a catalytic converter is detected), an increase in pollutants being emitted can be estimated or determined, and the duration of time or miles driven until the system is repaired can be determined. Additionally, by monitoring vehicle parameters, the duration of time the engine is running, the miles the vehicle 110 travels during a certain period of time, and/or how the vehicle 110 is operated (e.g., whether the vehicle 110 is driven in the city or on the interstate and/or whether the vehicle 110 is operated conservatively or driven hard) can be determined.

Positioning data supplied by the positioning system 118 to the controller 116 can also be used to determine the miles traveled by a vehicle 110, departure and arrival points, and the route taken by the vehicle 110 between various points. The positioning data can be combined with other information to determine vehicle use or nonuse, the amount of emission units saved by certain types of vehicle operations (including nonuse of the vehicle 110), and/or whether the vehicle 110 follows preferred routing between certain locations. Additionally, in certain embodiments if the vehicle's emission system malfunctions, the vehicle's position can be used to determine the distance to the nearest repair station and the distance the vehicle is driven in excess of the distance to the nearest repair station before the emission system is repaired, if any.

As discussed above, the controller 116 sends information (e.g., data) regarding the systems over at least one network to a computing system 140, where the information can be analyzed, stored, and/or managed. In certain embodiments, the controller 116 can correlate a vehicle identification with information that is sent to the computing system 140. For example, the vehicle identification can include a Vehicle Identification Number that a controller receives from the electronic control unit or other vehicle component, an assigned identification number retained in a controller memory 121, or an associated wireless or computing device address (e.g., an electronic serial number, mobile directory number, or uniform resource location).

Also as discussed above, the information collected by the controller 116 can be used to determine emission units or credits and/or combined with other information to determine emission units or credits. In certain embodiments, the information can be analyzed by the controller, and the emission units and/or credits can be sent to the computing system 140 with the vehicle identification. Accordingly, additional information needed to perform the analysis can be stored in an associated memory or database (e.g., the controller memory 121). In other embodiments, the information collected by the controller 116 can be sent to the computing system 140 with the vehicle identification and the computing system 140 can perform the necessary analysis to determine emission units and/or credits. Accordingly, additional information need to perform the analysis can be stored in an associated memory or database 142 and/or be obtained from other computing devices (e.g., via a network connection). In still other embodiments, a portion of the analysis to determine emission units and/or credits can be performed by the controller 116 and a portion of the analysis can be performed by the computing system 140.

In the illustrated embodiment, the controller 116 sends information to the computing system 140 via a communication device 117 via first network 130 to a computer server 132 (e.g., a wireless service provider's server). The computer server 132 then sends the information to the computing system 140 via a second network 135 (e.g., the Internet, local area network, or modem and phone connection). In certain embodiments, the first network 130 can be a wireless network and/or provide communication from the communication device 117 directly to the computing system 140.

In the illustrated embodiment, the communication device 117 can include a telemetry transceiver or transmitter permanently installed in the vehicle 110. The transceiver or transmitter can be configured to communicate with a wireless system (e.g., cellular networks, satellite communication networks, and/or radio networks including XM radio). In other embodiments, the communication device 117 can have other arrangements. For example, in certain embodiments the communication device 117 can include a cellular phone that is removable from the vehicle 110, but configured to interface or integrate with the controller 116. The controller 116 can store the information (e.g., systems information, emission units, and/or emission credits) in the controller memory 121 and send the information to the computing system 140 when the cellular phone is integrated with the controller 116. In other embodiments, the communication device 117 can include a wired or wireless interface configured to communicate with a remote download station 155 (e.g., a drive-up station, a drive-up kiosk, and/or a computer connection located in a vehicle operator's garage). When the communication device 117 is in communication with the remote download station 155, the controller 116 can send information to the computing system 140 via the first and second networks 130 and 135, as shown in FIG. 1, or via a single network directly to the computing system 140. In still other embodiments, the communication device 117 includes a device configured to download information from the controller 116 to a computer readable medium 152 (e.g., flash card, floppy disk, or CD) which can be read by a computing device 150.

In certain embodiments, controller 116 receives usage information (e.g., miles traveled, fuel used, and/or duration of operation) from systems on board the vehicle 110 and a saved or assumed emissions profile for the vehicle is used to determine emission units and/or credits. For example, the results of a yearly or bi-yearly emissions test at an emissions test station 162 or a mobile emissions test facility 163 can be used to determine one or more emission rates (e.g., emission units produced by the vehicle 110 per mile and/or per gallon of fuel used). In selected embodiments, the rate(s) of emission production can be sent via at least one network to the computing system 140 where it can be stored (e.g., in memory or a computing system database 142) and/or used to determine emission units and/or credits based on vehicle operation. In other embodiments, the rate(s) of emission production can be sent from the test station 162 or mobile facility 163 to the controller 116 in the vehicle 110 via a wired or wireless interface, where it can be stored (e.g., in the controller memory 121) for later use and/or where at least a portion of the information can be sent to the computing device 140. In still other embodiments, the rate(s) of emission production can be sent to the computing device 140, which can in turn send at least a portion of the rate of emission production information to the controller 116.

The controller 116 can then track the operation of the vehicle and the saved emission profile can be used to determine emission units and/or credits. For example, in one embodiment, the controller tracks the amount of fuel used or not used and/or the number of miles driven or not driven during a selected period. The emission units and/or credits for the selected period of time can then be determined using a stored emission rate. In other embodiments, multiple emission rates can be used for various types of driving (e.g., based on RPM levels, vehicle speed, or intake vacuum pressure) or various vehicle locations (e.g., city, country, interstate). In still other embodiments, emission credits can be based on the use of the vehicle once an emission saving item is installed.

In another embodiment, emission rates can be assumed based on the type of car, the age of the car, and/or whether on-board monitoring of the emission system shows normal operation of the emission system or shows a malfunction. The controller 116 can track the amount of fuel used and/or miles traveled during a selected period of time. The emission units and/or credits for the selected period of time can then be determined using the assumed emission rate(s). In other embodiments, multiple assumed emission rates can be used for various types of driving or for various vehicle locations.

As discussed above, the computing system 140 can receive information from the controller 116 and can analyze, store, and/or manage the information. For example, in certain embodiments the computing system 140 can include computing device(s) 150 (e.g., personal computer(s), displays, printers, hand-held device(s) such as PDAs, and the like), computer server(s) 132, a networking environment, database(s) 142, and the like. The computing system can also communicate with other computing devices 150 via one or more networks. In the illustrated embodiment, the computing system 140 can communicate with two computing devices 150, shown as a first computing device 150a and a second computing device 150b via the second network 135. In other embodiments, the computing system can communicate with more or fewer computing devices 150 and/or communicate with various computing devices 150 via other arrangements (e.g., via multiple networks).

The computing system 140 can store and manage information regarding a vehicle, including emission units and/or emission credits. For example, in the illustrated embodiment a first entity (e.g., a person, a group of people, a company, or other organization) can use the first computing device 150a to register the vehicle 110 for emissions tracking. The computing system 140 can store emission units and/or credits associated with the vehicle 110 and the first entity can use the first computing device 150a to manage the emission units and/or credits associated with the vehicle.

For example, in certain embodiments a second entity that may not be able to meet regulatory emission requirements might wish to purchase emission credits to offset the emission units that are in excess of the second entity's regulatory requirements. Accordingly, the second entity can use the second computing device 150b to purchase (e.g., for cash or merchandise) emission credits from the first entity or the first entity can voluntarily donate a selected number of emission credits to the second entity. In other embodiments, the first entity might use emission credits from one vehicle to offset emission units in excess of regulatory requirements (e.g., created by the vehicle 110 during a different time period, created by another vehicle, created by a non-vehicle pollution source, and/or created by another pollution source). In still other embodiments, emission credits can be traded as a commodity and a broker can purchase emission credits from one or more entities and sell at least a portion of the collected credits to another entity. In yet another embodiment, the computing system 140 can be used to show that an entity is complying with regulatory or other requirements (e.g., to monitor the entity). For example, the computing system 140 can be used to show that a fleet of cars meets a set of state mandated emission requirements. In still other embodiments, the computing system 140 can be used to assess the performance of various programs (e.g., to assess the actual impact of an entity's rideshare program).

Although various embodiments of the present invention are discussed herein with reference to motor vehicles such as cars, trucks, and motorcycles, one skilled in the art will recognize that many embodiments can be used in conjunction with other types of vehicles including ships, boats, trains, and aerospace vehicles. Also, although many embodiments are discussed herein in the context of monitoring an emission unit/credit associated with a single pollutant or a selected group of pollutants, in other embodiments multiple types of emission units/credits can be tracked for a selected vehicle. For example, in selected embodiments a first type of emission credit associated with carbon monoxide can be tracked and a second type of emission credit associated with sulfur can also be tracked.

FIGS. 2-8 include schematic illustrations of computer displays that can be used to track and/or manage vehicle emissions data or information via the computing system 140, shown in FIG. 1. For example, in certain embodiments, a user can access the computer displays via the first computing device 150a (also shown in FIG. 1). In other embodiments, the computer displays can have other arrangements. For example, more or fewer displays can be used to track and/or manage vehicle emission data, and/or different displays can be used. In still other embodiments, a user can access the computer displays via the controller 116 in the vehicle (shown in FIG. 1) and/or the user can include an operator who interfaces with the user and who accesses the computing system 140 directly (e.g., via a computer terminal that is part of the computing system 140).

FIG. 2 is a schematic illustration of a computer display that can be used to track and manage vehicle emissions. The computer display provides a user with general information 280 about emission tracking and several links 282 to other display pages that allow the user to register a vehicle, track emission units and/or credits, trade emission units and/or credits (e.g., assign emission credits to a selected entity in exchange for consideration), transfer ownership of emission units and/or credits, and to perform other functions (e.g., administrative functions, obtain help information, and/or to obtain more detailed information regarding emissions tracking). Additionally, the displays can present one or more advertisements 290 to the user. The advertisement(s) can include relevant information related to emission tracking or unrelated information (e.g., advertising unrelated products).

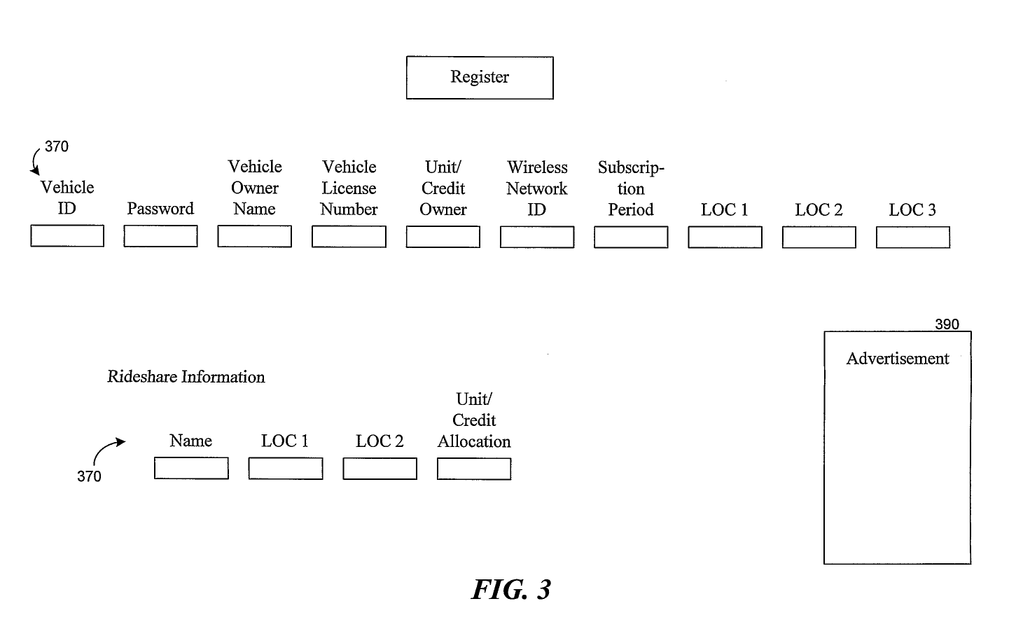

FIG. 3 is a schematic illustration of a computer display that can be used to register a vehicle for emission tracking. The display includes several fields 370 where the user can enter information. For example, the fields 370 can include the vehicle identification, a password, the name of the vehicle owner(s) (e.g., one or more entities), and the license plate number of the vehicle. The fields 370 can also include the name of the owner(s) (e.g., one or more entities) of the emission units/credits (e.g., the car owner may have assigned emission credits to a manufacturer in exchange for a rebate or a discount on the purchase price of the car).

In certain embodiments, the fields 370 can include a wireless network identification, for example, when a removable cell phone is used to exchange information between the controller and the computing system discussed above. In other embodiments, the fields 370 can also include a subscription period or the period of time during which emissions will be tracked. In still other embodiments, the fields 370 can include one or more locations. For example, a first location can be the residence of the vehicle's operator, a second location can be the location where the vehicle's operator works, and the third location can be an emission test station nearest to the operator's residence or workplace.

In yet other embodiments, the display can include entry fields 370 for rideshare information including the name of a rider, locations between which the rider will ride, and whether the emission units/credits are shared with the rider. Additionally, the registration page can include advertisement information 390. Other embodiments can have more, fewer, or different fields 370. In certain embodiments, certain fields 370 can be automatically filled in based on information entered in other fields or the information can be entered at a later time (e.g., by a systems operator) after verifying one or more pieces of the entered information.

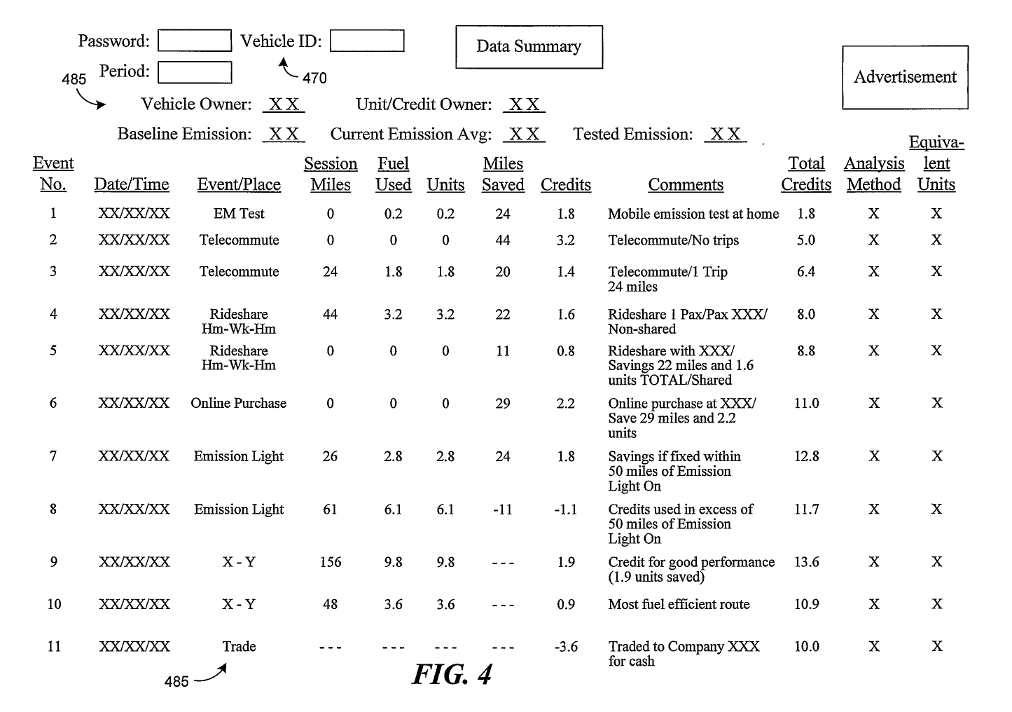

FIG. 4 is a schematic illustration of a computer display that can be used to track vehicle emissions and/or emission units/credits (e.g., a data summary page). The data summary page can include entry fields 470 where a user can enter the vehicle identification, a password, and a time period of interest. Once the information has been entered into the entry fields 470, data 485 regarding the vehicle can be displayed. For example, the name of the vehicle owner and the name of the unit/credit owner can be displayed. Additionally, in certain embodiments, a baseline emission level, a current emission average, and a tested emission level can be displayed. For example, the baseline emission level can include a regulatory maximum emission level (e.g., emission units per mile) or the expected emission level for the vehicle type. The current emission average can include the current emission level the vehicle has achieved over a selected period of time. The tested emission level can include the results of the last emission test conducted on the vehicle or expected emission level. As discussed above, in various embodiments these levels can be used to determine emission units/credits based on vehicle operation or nonuse. In other embodiments more or fewer levels can be displayed, including no emission levels.

The data 485 can also include data associated with various events. In the illustrated embodiment data for eleven events are shown. In certain embodiments, the data for each event can include the event number, the date and time of the event, the name of the event and/or the place or location where the event occurred. In other embodiments, the data can also include the session miles or miles driven during the event. In still other embodiments, the data can include the fuel used during the event, the emission units created during the event, the miles saved during the event (e.g., miles saved by actions associated with the event), and the emission credits created by the event. In yet other embodiments, the data can include comments regarding the event, a running total of emission credits for the vehicle, the analysis method used to compute the units/credits (e.g., whether an assumed emission rate was used or an actual emission rate was used), and an equivalent units representation of the emission credits. For example, in certain embodiments emission units/credits can be represented in non-dimensional units or in units that correlate to other performance factors (e.g., correlate to an amount of fuel, a number of miles, or an amount of BTUs used or saved) and the equivalent units representation can provide a conversion to other units (e.g., the weight of the selected pollution particulates used or not produced). In other embodiments, the display can have more or fewer events.

In the illustrated embodiment, the first event illustrates emission savings or emission credits earned by using a mobile emission testing facility where a non/low-polluting electric, hybrid, or other low pollution vehicle tows or carries the emission test station to the vehicle's operator's residence and conducts the required emission test (e.g., a yearly or bi-yearly emission test required by a government agency). Because the vehicle was not driven to an emission test station, the round trip mileage (e.g., 24 miles) between the residence and the test station was saved. Correspondingly, the associated emissions that would have been produced by the round trip have been saved and are shown in the form of emission credits (e.g., 1.8 emission credits). In other embodiments, emissions corresponding to the round trip to the emission station can be saved using other methods. For example, in certain embodiments, vehicle emissions can be continuously monitored by the controller and computing system discussed above with reference to FIG. 1, negating the need for a yearly or bi-yearly test. In still other embodiments, other continuous/remote monitoring programs can be used to negate the need to travel to an emission testing station (e.g., using an OBD system and a telematic device to report emission information).

The second event illustrates the miles and gas saved by the operator telecommuting during a scheduled work day. Because the vehicle was not driven to work, the associated emission credits can be earned. Additionally, unlike other telecommuting programs where the vehicle can still be operated while the worker is working at home during telecommuting hours (e.g., a worker's spouse operates the vehicle), the controller can be used to determine if the vehicle was operated and/or the extent of vehicle operations during the associated period to determine the actual amount of savings as compared to the worker's car being driven to work, parked, and driven home. For example, in the third event the vehicle was driven during the telecommuting period for a distance of 24 miles and the amount of emission credits earned by telecommuting has been correspondingly reduced. This feature can also be used to assess the effectiveness of telecommuting programs and/or the actual amount of pollution that is prevented by a telecommuting program. In certain embodiments, operation of the vehicle corresponding to a lunch period can be allowed or compensated for during the telecommuting period.

The fourth event illustrates the pollution that is prevented by a rideshare program (e.g., where the baseline used to determine emission credits includes the number of people expected to be in a vehicle for the emission units produced). For example, emission credits can be determined for the amount of emission units that the rider would have used, had the rider used the rider's own vehicle to transit the portion of the route where the rider and operator occupy one vehicle. In a certain embodiment, the operator can indicate via an input to the controller or to the computing system (e.g., via a computing device and a network) that the rider will be in the vehicle during a selected period of operation. In other embodiments, the rider can be registered in a rideshare program and the rider or user can indicate when they are ridesharing or not ridesharing. In still other embodiments, the controller can monitor systems in the vehicle to determine vehicle occupancy. For example, a weight sensor in each seat can be monitored, an infrared device can be used to determine which seats in the vehicle are occupied, and/or a sensor can sense an electronic signal associated with the rider (e.g., a cellular phone, a magnetically coded card, and/or the presence of a PDA with wireless connectivity).

In other embodiments, rideshare participants can share the emission credits earned by rideshare participation. For example, as illustrated in FIG. 3, rideshare participants can arrange to share the emission credits earned via a rideshare program on a percentage basis. Accordingly, as illustrated by the fifth event (in FIG. 4), when participants share a ride, the emission credits can be shared between the participants based on the selected percentages. In certain embodiments, the selected percentages between participants could change depending on which participant's vehicle is being used on any given day.

The sixth event illustrates how emission credits can be earned by remotely conducting business and thereby avoiding vehicle operation. For example, in the illustrated embodiment an online purchase was made from a retailer who also has a local store where the operator could have physically made the purchase. Accordingly, emission credits can be determined based on the emission units that would have been required to drive to and from the physical store location. In certain embodiments, the retailer information can be stored in the computing system and include the physical location of the store to aid in determining the emission credits earned. In other embodiments, the emission credits earned can be offset by an estimated amount of emission units required to deliver (e.g., via mail or overnight carrier) the purchased merchandise. In still other embodiments, emission credits can be earned by remotely conducting business in other ways. For example, similar emission credits can be earned by placing a telephone order with a qualifying retailer having a local store in the area (e.g., the retailer can document the purchase with the computing system discussed above with reference to FIG. 1).

The seventh event illustrates how emission credits can be earned by promptly repairing malfunctioning portions of the vehicle's emissions system. For example, a budget of miles before repairs are expected to be made (e.g., 50 miles) can be used to determine whether the emissions system was promptly repaired. In the illustrated embodiment, the seventh event shows that the emission system malfunction was corrected within 26 miles of the failure being annunciated (e.g., an engine check light is illuminated). Because the malfunction was corrected 24 miles under a 50 mile budget, emission credits corresponding to 24 miles can be earned. For example, a high pollution rate can be assumed and used to determine emission units and/or credits when a malfunctioning emission system annunciation is displayed.

In other embodiments, the actual (e.g., measured) pollution rate can be used to determine associated emission units and/or credits during emission system malfunctions. In certain embodiments where the malfunctioning emission system is not promptly repaired (e.g., repaired within the selected budget) negative emission credits can be earned. In selected embodiments where a serviceman is dispatched in a service vehicle to repair or tow a vehicle with the malfunctioning emission system, the emission units produced by the service vehicle (e.g., a normal or low emissions vehicle) can be monitored and applied against the budgeted miles and/or emission credits allotted for repair of the malfunctioning emission system.

In certain embodiments when excessive emission units are created the total number of emission credits can be reduced. For example, as illustrated by the eighth event if the vehicle is operated with an emission system failure over a budgeted amount, the excess of emission units resulting from operation of the vehicle beyond the budgeted amount can produce negative emission credits and/or cause a reduction in accumulated emission credits. This feature can provide incentive for operators to properly maintain their vehicles and/or provide a more comprehensive picture of the total pollution created by the vehicle over a period of time.

The ninth event illustrates how emission credits can be earned for good emissions performance. For example, when a vehicle is operated conservatively (e.g., slow acceleration and deceleration rates) the vehicle can burn less fuel over a selected distance and/or produce less pollution than when a vehicle is driven hard. Accordingly, emission credits can be earned when a vehicle produces less pollution than would be expected when traveling over a certain distance or route. In certain embodiments, vehicle performance can be affected by other factors. For example, proper tire inflation and/or non-use of an air-conditioning system can decrease the fuel burned and the pollution created when a vehicle is operated over a selected distance or route. Other factors can increase fuel consumption and pollution, for example, when a vehicle is towing a trailer and/or has under-inflated tires. In still other embodiments, emission credits can be earned for the pollution savings associated with the performance of a hybrid, electric, or other low pollution vehicle as compared to a conventional car (e.g., an average conventional car) or other baseline.

The tenth event illustrates how emission credits can be earned when a vehicle operator chooses a preferred routing that provides emission savings. For example, the controller and/or the computing system can include preferred routings that generally create less pollution when traveling between selected points. For example, in certain situations fuel consumption and pollution can be reduced by taking a longer route and avoiding stop and go traffic. In other embodiments, preferred routings can include routes that avoid areas that tend to collect high levels of pollution (e.g., where traffic is concentrated and/or there are few air currents to carry pollution away). Accordingly, when a preferred routing is used by a vehicle operator, emission credits associated with the preferred routing can be earned (e.g., the estimated or assumed number of emission credits created by taking the preferred routing). In selected embodiments, the vehicle can include a computing device (shown as 150d in FIG. 1) that provides information related to a preferred routing with regard to emission credits and/or other information regarding emission credits (e.g., a running total of accumulated emission credits, a budgeted amount of miles allotted for the repair of a malfunctioning emission system, the number of miles remaining from the budgeted amount of miles allotted for the repair of the malfunctioning emission system, and the like). As discussed in further detail below, the computing device 150d can include a display or printer can communicate with various vehicle systems and/or various portions of the system 100 (shown in FIG. 1) used for determining, tracking, and/or managing emission units and/or credits.

The eleventh event illustrates how trading emission credits can affect the running total of emission credits associated with a vehicle. In the illustrated embodiment, 3.6 emission credits have been traded to Company XXX. Accordingly, the total number of emission credits has been reduced by the 3.6 credits. The data summary, illustrated in FIG. 4 can provide a quick look at the total number of emission credits that have been earned by a vehicle and/or been traded during a selected period of time. Additionally, in certain embodiments the data summary can provide other information (e.g., running total of emission units produced by the vehicle). Although various events associated with creating, tracking, trading, and managing emission credits have been discussed above for the purpose of illustration, it is understood that the invention is not limited to these events and can include other events that produce emission units and/or credits.

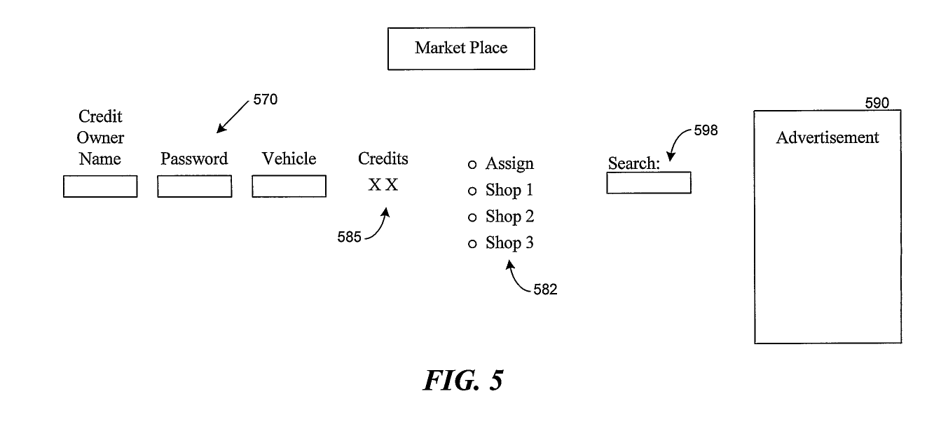

FIG. 5 illustrates a computer display that can be used to trade emission credits. In the illustrated embodiment, data entry fields 570 allow a user to enter the name of the credit owner, a password, and a vehicle identification. After data has been entered in the data entry fields 570, data elements 585 (e.g., the total number of credits) can be displayed. Additionally, several links 582 can be displayed so that a user can select different options (e.g., entities) for trading emission credits. Additionally, the display can include advertisements 590. For example, the advertisements 590 can include advertisements associated with the various entities that accept emission credits or wish to purchase emission credits for consideration (e.g., goods, services, tax credits, cash, and the like). In selected embodiments, a search feature 598 can be provided that allows the user to search for a specific item, service, charity, or the like that accept emission credits. In other embodiments, the search feature 598 can allow the user to search for the “best deal” available with regard to trading emission credits for a selected item or service. In other embodiments, the search feature 598 can provide a list of entities looking to buy emission credits and/or the highest price being offered for emission credits.

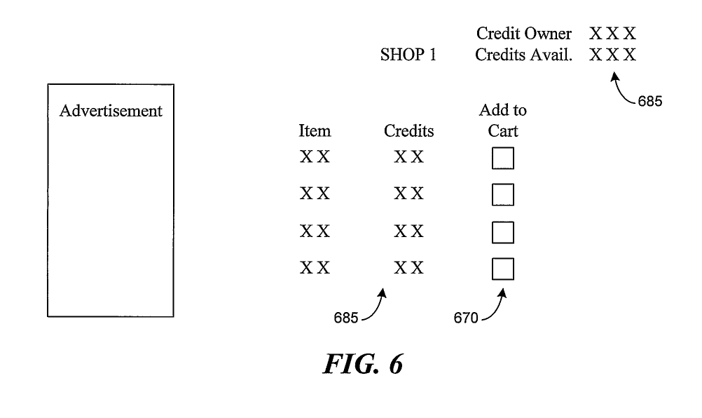

FIG. 6 illustrates a computer display that is displayed in response to the user (e.g., an entity) selecting the shop 1 link 582 shown in FIG. 5. In FIG. 6, various data elements 685 can be displayed. For example, a list of goods and/or services (e.g., downloadable digital media such as music and videos) which can be purchased using emission credits and the number of emission credits required to purchase each item can be displayed. The name of the entity that owns the emission credits and the number of available emission credits are also displayed. Data entry fields 670 are provided so that a user can select and receive one or more of the items in trade for a selected number of emission credits. In certain embodiments, the entity buying the emission credits can use the emission credits for various purposes. For example, the buying entity can sell the emission credits to another entity that requires emission credits to offset emission units in order to meet regulatory requirements, the buying entity can use the emission credits to offset its own emission units, and/or the buying entity can receive an incentive for collecting emission units (e.g., a tax break).

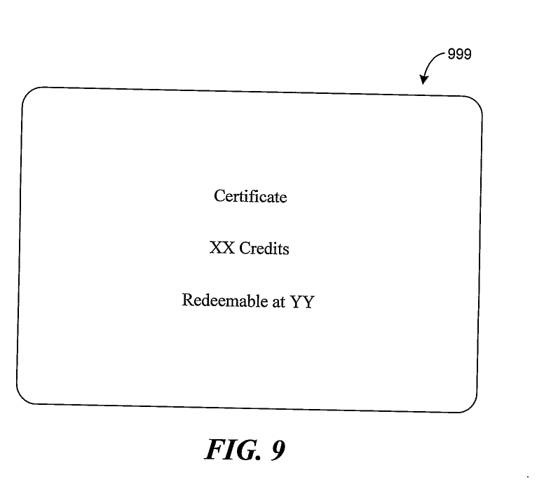

In other embodiments, emission credits can be assigned or traded in other ways. For example, in certain embodiments a user can enter a merchant's place of business and a display, similar to the display shown in FIG. 6, can be used by the user and/or a sales clerk to trade emissions for merchandise. In other embodiments, a computing device associated with the computing system can include a printer and a certificate, document, or other type of printout 999 (shown in FIG. 9) that represents a portion of the user's total emission credits can be printed. The user's emission credit total can be reduced by the value shown on the printed document. The certificate, document, or printout can then be carried to one or more participating merchants and exchanged for consideration.

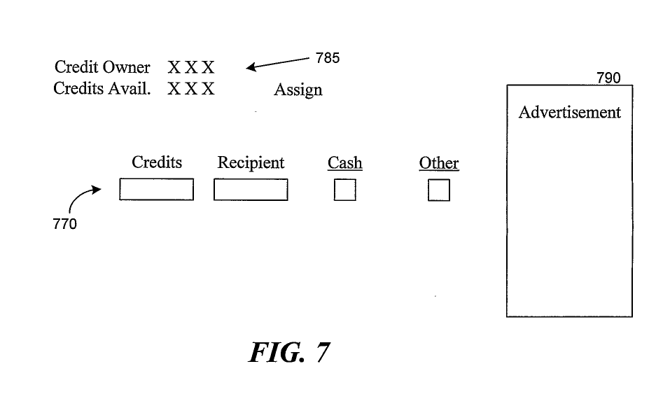

FIG. 7 illustrates a computer display that is displayed in response to the user selecting the Assign link 582 shown in FIG. 5. In the illustrated embodiment, the Assign display allows a user to trade emission credits to another entity that requires or desires to buy the emission credits for cash or other consideration. In FIG. 7, various data elements 785 can be displayed. For example, in the illustrated embodiment, the name of the entity that owns the emission credits and the number of available emission credits are displayed. An advertisement section 790 is also displayed and can include a list of entities willing to purchase emission credits. In certain embodiments, the advertisement can also include the price that various entities are willing to pay for emission credits. Data entry fields 770 are provided so that a user can select the number of emission credits that the user wishes to trade, the recipient of the credits, and the type of compensation or consideration (e.g., cash or other) that the user desires to receive for the credits. For example, in certain embodiments the emission credits can be traded similar to, or as a commodity, and the price of emission credits can fluctuate in accordance with supply and demand.

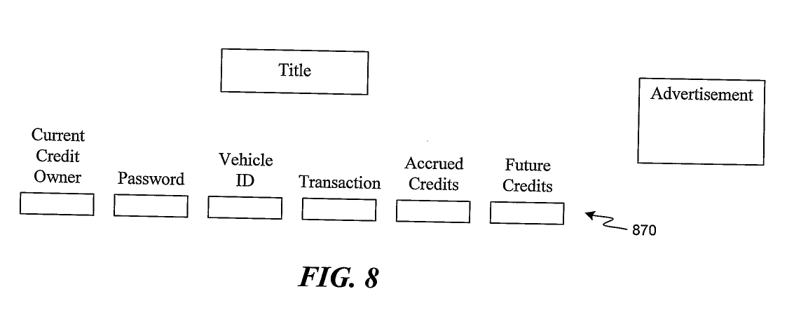

FIG. 8 illustrates a computer display used to manage the title issue surrounding emission units and/or credits. For example, in certain embodiments, the accumulated emission credits earned and/or rights to future emission credits can be transferred with the vehicle when the vehicle is sold. For example, the emission units/credits can be transferred to a single entity or the accrued credits can be transferred to a first entity and the rights to future credits can be transferred to a second entity. In other embodiments, the accumulated emission credits can remain with the entity that owned the emission credits when the emission credits were earned, and rights to future emission credits can be transferred (e.g., assigned to a selected entity) when the vehicle is sold.

In other embodiments, the accumulated emission credits and the rights to future emission credits are not transferred when a vehicle is sold. For example, when a vehicle dealer reduces the purchase price of a vehicle or provides a purchase rebate for a car in exchange for the rights to the emission credits over a period of time (e.g., the life of the vehicle), the vehicle dealer can retain title to accrued and future emission credits when the vehicle is subsequently sold to a third party. In other embodiments, when a vehicle is sold there are no future rights to emission credits (e.g., the new owner would be required to sign up to participate in an emission tracking program in order to receive emission credits). In still other embodiments, the accumulated emission credits earned and/or rights to future emission credits can be transferred (e.g., sold) to another entity without the vehicle being sold.

The display in FIG. 8 provides a user with data entry fields so that the user can select the disposition of accumulated emission credits and the rights to future emission credits when a vehicle is sold. For example, the data entry fields 870 can include the name of the current owner of emission credit rights, a password, a vehicle identification, the type of transaction associated with the change in emission credit rights, the name of the entity receiving the accrued credits, and the name of the entity receiving the rights to future credits. In certain embodiments, the rights to emission credits can be attached to the vehicle and recorded with the vehicle title. As discussed above, in other embodiments the assignment of credits to another entity can be accomplished in other ways, including via paper documents.

Although various features of embodiments discussed above have been illustrated using a computing system or computer implemented method, many or all of these features can be accomplished in other ways (e.g., without using a computer). Additionally, although various features of embodiments discussed above have been illustrated using a vehicle, many or all of these features can be applied to other pollution sources (e.g., buildings, factories, and the like). For example, selected embodiments of the invention can include a method for tracking emission credits that includes collecting emission units associated with a pollution source. The emission units represent (a) an amount of one or more selected pollutants, (b) an amount of thermal energy, or (c) both (a) and (b). The method can further include determining emission credits by comparing the collected emission units with a baseline. The method can further include maintaining a total number of emission credits over a selected period of time and providing a way to assign a portion of the total emission credits to a selected entity.

Additionally, many of the features of embodiments discussed above have been illustrated using one or more computer networks such as the Internet. In other embodiments, the Internet or a network are not required to accomplish many or all of these various features. For example, in certain embodiments some or all of the computing system elements (shown in FIG. 1) can be carried by the vehicle. The computing system can track the total emission credits as described above. When a first entity wishes to assign a portion of the emission credits to a second entity (e.g., to trade emission credits for consideration), the total emission credits can be displayed in the vehicle and/or printed in a document via an onboard computing device that includes a printer. The display or document can be used to conduct the transaction between the first and second entity. For example, in selected embodiments the computing system in the vehicle can printout a certificate or other record of emission credits that can be exchanged for consideration.

A feature of embodiments discussed above is that the amount of pollution created by a vehicle and/or the amount of pollution saved by certain kinds of operation of a vehicle can be more accurately tracked than with current systems or programs (e.g., with current telecommuting programs). Additionally, this increased accuracy can allow incentive programs and regulatory programs to be better assessed with respect to their effectiveness in reducing pollution.

Another feature of embodiments discussed above is that pollution units and/or credits can be tracked, traded, and managed. This can allow certain entities that are unable to meet various pollution requirements to purchase credits to offset excessive pollution units that they create. Additionally, because pollution credits can be traded or redeemed for compensation or consideration (e.g., money or merchandise), users can be motivated to reduce pollution and/or compensated for the cost of reducing emissions. Furthermore, because individual vehicle users can participate in earning and trading emission credits, the individual users can be motivated to reduce pollution as juxtaposed with current programs that target large pollution sources (e.g., fleets or cars or employees of large businesses).

Furthermore, in certain embodiments the emission credits created by one type of pollution source can be used to offset excessive emission units created by other types of pollution sources. For example, pollution credits created by vehicles can be used to offset excessive emission units created by a factory.

An advantage of these features is that pollution created by a vehicle can be more accurately tracked, programs to reduce emissions can be more accurately assessed, and individual users can be motivated to reduce the amount of pollution created by vehicle operations.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” Additionally, the words “herein,” “above,” “below,” and words of similar import, when used in this application, shall refer to this application as a whole and not to any particular portions of this application. When the description or the claims use the word “or” in reference to a list of two or more items, that word covers all of the following interpretations of the word: any of the items in the list, all of the items in the list, and any combination of the items in the list.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times. Where the context permits, words in the above Detailed Description using the singular or plural number may also include the plural or singular number respectively.

The teachings of the invention provided herein can be applied to other systems, not necessarily the system described herein. The elements and acts of the various embodiments described above can be combined to provide further embodiments.

All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

These and other changes can be made to the invention in light of the above Detailed Description. While the above description details certain embodiments of the invention and describes the best mode contemplated, no matter how detailed the above appears in text, the invention can be practiced in many ways. Details of the system may vary considerably in its implementation details, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention.

I/We claim:

1. A system for tracking emission credits, comprising:
a wireless collector configured to collect emission units data associated with at least one vehicle via a wireless network, wherein the at least one vehicle includes a monitoring system carried by the at least one vehicle, and wherein the emission units data represents (a) an amount of one or more selected pollutants, (b) an amount of thermal energy, or (c) both (a) and (b); and
a data processing platform coupled to receive the emission units data, and being configured to:
compute emission credits data by comparing the collected emission units data with a baseline;
maintain a total number of emission credits over a selected period of time;
receive a command signal from a first entity to assign a portion of the total emission credits to at least one second entity in exchange for consideration; and
assign a portion of the total emission credits to the at least one second entity in exchange for consideration.

2. The system of claim 1 wherein the data processing platform includes a computer server and the wireless collector includes a wireless network.

3. The system of claim 1 wherein the data processing platform includes a computer server and the wireless collector includes a wireless network and wherein the data processing platform is configured to receive the command signal from the first entity via a computing device coupled to the computer server via the wireless network or another network.

4. A system for tracking emission credits, comprising:
a collector configured to collect emission units data associated with at least one vehicle, wherein the emission units data represents (a) an amount of one or more selected pollutants, (b) an amount of thermal energy, or (c) both (a) and (b); and
a data processing platform coupled to receive the emission units data, and being configured to:
compute emission credits data by comparing the collected emission units data with a baseline; and
maintain a total number of emission credits over a selected period of time.

5. The system of claim 4 wherein the data processing platform is configured to produce a signal for use in assigning a portion of the total emission credits to at least one selected entity.

6. The system of claim 4 wherein the data processing unit is configured to produce a signal suitable to produce at least one of a printout and a display representing a portion of the total emission credits for use in assigning the portion of the total emission credits to at least one selected entity.

7. The system of claim 4 wherein the data processing platform is configured to produce a signal for use in assigning a portion of the total emission credits to at least one selected entity in exchange for consideration.

8. The system of claim 4 wherein the data processing platform is configured to produce a signal for use in assigning a portion of the total emission credits to at least one selected entity in exchange for (a) goods, (b) services, or (c) both (a) and (b).

9. The system of claim 4 wherein the collector is configured to collect emission units data from a monitoring system carried by the at least one vehicle.

10. The system of claim 4 wherein the collector is configured to collect emission units data via a wireless network from a monitoring system carried by the at least one vehicle.

11. The system of claim 4 wherein at least a portion of the data processing platform is carried by the at least one vehicle.

12. The system of claim 4, further comprising a printer carried by the vehicle, wherein the data processing platform is operably coupled to the printer and configured to provide a signal to the printer to cause the printer to print a document representing a portion of the total emission credits for use in assigning the portion of the total emission credits to at least one selected entity.

13. The system of claim 4 wherein the data processing platform is configured to assign the emission units to a first entity and wherein the data processing platform is configured to produce a signal for use in assigning a portion of the total emission credits to at least one second entity.

14. A system for tracking emission credits, comprising:
means for collecting emission units associated with at least one vehicle via a wireless network from a monitoring system carried by the at least one vehicle, the emission units representing (a) an amount of one or more selected pollutants, (b) an amount of thermal energy, or (c) both (a) and (b);
means for computing emission credits by comparing the collected emission units with a baseline;
means for maintaining a total number of emission credits over a selected period of time;
means for receiving a command from a first entity to assign a portion of the total emission credits to at least one second entity in exchange for consideration; and
means for assigning a portion of the total emission credits to the at least one second entity in exchange for consideration.

15. The method of claim 14 wherein at least one of the means for computing emission credits, the means for maintaining a total number of emission credits, and the means for assigning a portion of the total emission credits is carried by the at least one vehicle.

16. A computer-implemented method for tracking emission credits, comprising:
collecting emission units associated with at least one vehicle, the emission units representing (a) an amount of one or more selected pollutants, (b) an amount of thermal energy, or (c) both (a) and (b);
computing emission credits by comparing the collected emission units with a baseline; and
maintaining a total number of emission credits over a selected period of time.

17. The method of claim 16, further comprising providing a signal for use in assigning a portion of the total emission credits to at least one selected entity.

18. The method of claim 16, further comprising providing a signal suitable for producing at least one of a printout and a display representing a portion of the total emission credits for use in assigning the portion of the total emission credits to at least one selected entity.

19. The method of claim 16, further comprising providing a signal for use in assigning a portion of the total emission credits to at least one selected entity in exchange for consideration.

20. The method of claim 16, further comprising providing a signal for use in assigning a portion of the total emission credits to at least one selected entity in exchange for (a) goods, (b) services, or (c) both (a) and (b).

21. The method of claim 16 wherein collecting emission units includes collecting emission units obtained from a monitoring system carried by the at least one vehicle.

22. The method of claim 16 wherein collecting emission units includes collecting emission units via a wireless network from a monitoring system carried by the at least one vehicle.

23. The method of claim 16 wherein computing emission credits includes using a computing system to compute emission credits and wherein at least a portion of the computing system is carried by the at least one vehicle.

24. The method of claim 16, further comprising printing a document representing a portion of the total emission credits for use in assigning the portion of total emission credits to at least one selected entity.

25. The method of claim 16, further comprising printing a document representing a portion of the total emission credits for use in assigning the portion of total emission credits to at least one selected entity, wherein the document is printed by a printer carried by the at least one vehicle.

26. The method of claim 16 wherein computing emission credits includes assigning the emission credits to a first entity and wherein the method further comprises producing a signal for use in assigning a portion of the emission credits to at least one second entity.

27. The method of claim 16 wherein collecting emission units includes assigning the emission units to a first entity and wherein the method further comprises producing a signal for use in assigning a portion of the emission credits to at least one second entity.

28. The method of claim 16 wherein computing emission credits includes assigning at least a portion of the emission credits to a selected entity that is selected prior to the time when the emission units are collected.

29. The method of claim 16 wherein collecting emission units includes assigning at least a portion of the emission units to a selected entity that is selected prior to the time when the emission units are collected.

30. A computer-implemented method for tracking emission credits, comprising:
receiving a signal to assign (a) at least a portion of future emission units associated with at least one vehicle, (b) at least a portion of future emission credits associated with a vehicle, or (c) both (a) and (b) to a selected entity in exchange for consideration, wherein the emission units represent at least one of an amount of one or more selected pollutants and an amount of thermal energy, and wherein the emission credits are computed by comparing the collected emission units with a baseline;
collecting emission units associated with the at least one vehicle;
computing emission credits;
assigning (a) the at least a portion of future emission units associated with at least one vehicle, (b) the at least a portion of future emission credits associated with a vehicle, or (c) both (a) and (b) to the selected entity; and
maintaining a total number of emission credits over a selected period of time.

31. The method of claim 30 wherein the selected entity includes a first entity and wherein the method further comprises:
receiving a command to assign at least part of (a) the at least a portion of future emission units associated with at least one vehicle, (b) the at least a portion of future emission credits associated with a vehicle, or (c) both (a) and (b) to a second entity; and
assigning the at least part of (a) the at least a portion of future emission units associated with at least one vehicle, (b) the at least a portion of future emission credits associated with a vehicle, or (c) both (a) and (b) to the second entity
